(19) United States
(12) Patent Application Publication
(10) Pub. No.: US 2002/0062338 A1
(43) Pub. Date: May 23, 2002

(54) EXTENSIBLE THIN SERVER FOR COMPUTER NETWORKS

(76) Inventors: KEVIN SNOW MCCURLEY, SAN JOSE, CA (US); FLORIAN PESTONI, SAN JOSE, CA (US); BENJAMIN CLAY REED, SAN JOSE, CA (US); STEVEN RAY WELCH, GILROY, CA (US); JASON YEONG ZIEN, PALO ALTO, CA (US)

Correspondence Address: GATES & COOPER LLP, HOWARD HUGHES CENTER, 6701 CENTER DRIVE WEST, SUITE 1050, LOS ANGELES, CA, 90045, US

(21) Appl. No.: 09/163,498

(22) Filed: Sep. 30, 1998

(51) Int. Cl. G06F 15/16

(52) U.S. Cl. 709/203; 709/201

(57) ABSTRACT

A network computing device, known as a CyberHub, based on low-cost hardware and Java programming provides an architecture for extensible and inexpensive network connectivity and can be thought of as a combination of router and server in a box. The CyberHub provides all necessary functions with a small footprint and lightweight components, so that it can perform as an embedded device or thin server. The CyberHub can be employed in many different applications, ranging from an “instant office” to embedded network connectivity for remote devices.

### BACKGROUND OF THE INVENTION

1. Field of the Invention

The present invention generally relates to network computing applications, and in particular, to an extensible thin server for computer networks.

2. Description of Related Art

The role of information technology (IT) is pervasive and has extended to almost every possible business. However, some industries have taken more time to capitalize on the benefits of IT. More often than not, this is due to the significant investments for IT infrastructure.

The latest development in the computer industry has been the widespread use of networks. Although computer networks have been around for many decades, one recent change has been the commoditization of access to these networks. The Internet, and its sibling the corporate Intranet, have gone from military and research use to ubiquitous business and home appliance.

The network phenomenon is similar in many ways to the appearance of the personal computer, but is even more far reaching. The possibilities are endless and are not constrained to one single device. Rather, the network as a whole, including all its connected devices, becomes one huge computing platform. The importance of standards cannot be overrated, and the Internet is the best example of how to achieve collaboration among many parties.

The trend towards connectivity is changing the way companies do business. The ability to access information any time from anywhere is the key. More recently, the benefit of connecting devices not usually considered “computers” which handle digital data is being exploited. Remote sensing, remote management, etc., are some applications with a common theme: activities that used to require on-site presence of a human operator can now be centralized through the use of local or wide area networks, thus achieving greater efficiencies.

Nonetheless, the benefits of network computing are only beginning to be realized. Indeed, a number of obstacles still exist: security, reliability, systems complexity, interoperability, limited bandwidth, installed base of devices, ease of use, etc. All these issues need to be addressed in order to provide a solution that fits the needs of this industry. Thus, there is need in the art for cost effective ways of enabling computers and other digital devices to be connected to the Internet and Intranets.

### SUMMARY OF THE INVENTION

To overcome the limitations in the prior art described above, and to overcome other limitations that will become apparent upon reading and understanding the present specification, the present invention discloses a method, apparatus, and article of manufacture related to a network computing device that is based on low-cost hardware and provides an architecture for extensible and inexpensive network connectivity. The system architecture is multi-layered: (1) at a first layer, the system executes an operating system and networking software; (2) at a second layer, the system executes a Java Virtual Machine (JVM) that provides a platform for the execution of application services; and (3) at a third layer, the system comprises a software platform provides components for performing the basic functionality on which the application services are based. At least some of the components of the software platform include: one or more of the Services for grouping application-specific functions related to the managed device, one or more Class Loaders for loading the application-specific functions associated the Services, one or more Handlers for processing requests for the Services received from the network, a Registry for associating different ones of the Handlers with specific ones of the requests received from the network, and an Access Control List (ACL) Manager for controlling access to the resources of the computing device.

### BRIEF DESCRIPTION OF THE DRAWINGS

Referring now to the drawings in which like reference numbers represent corresponding parts throughout:

FIG. 1 is an exemplary hardware environment used to implement the preferred embodiment of the invention; and

FIG. 2 is a flowchart that illustrates the general logic of the preferred embodiment of the present invention.

### DETAILED DESCRIPTION OF THE PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

Hardware Environment

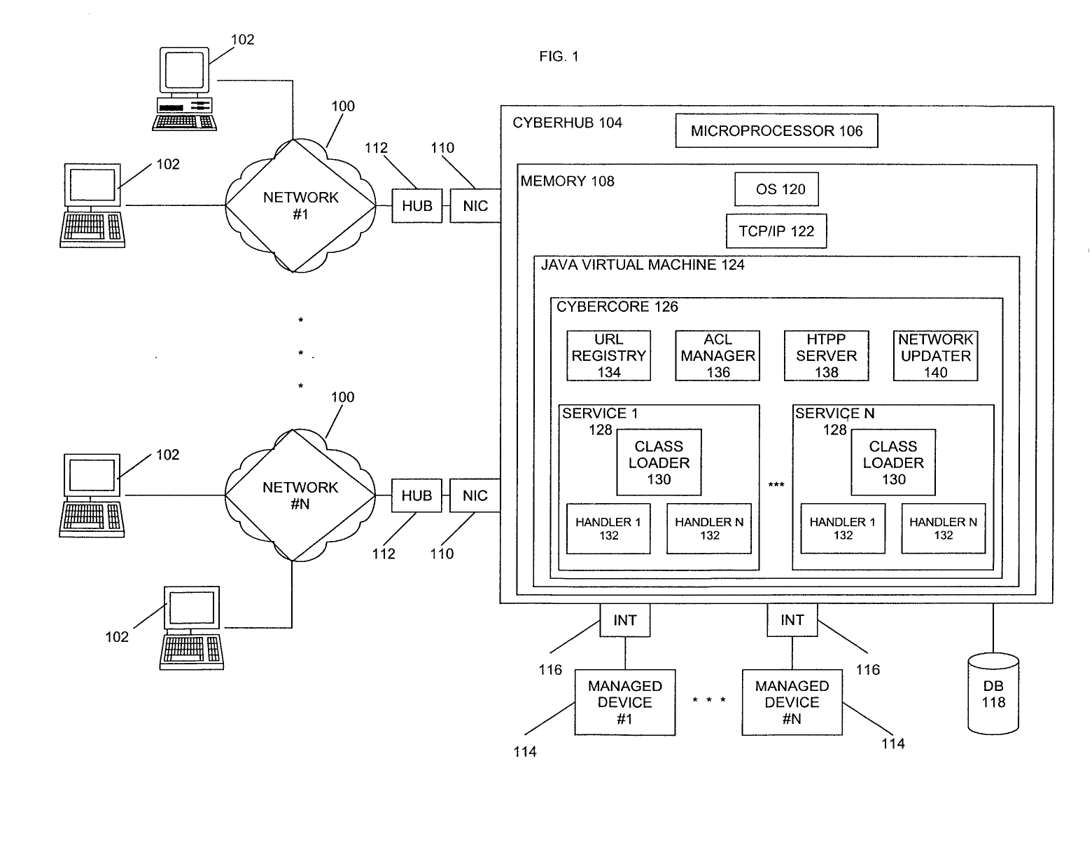

FIG. 1 schematically illustrates an exemplary hardware environment that may be used in the preferred embodiment of the present invention. The exemplary hardware environment comprises a networking environment 100, such as the Internet, an Intranet, LAN, WAN, etc. This networking environment 100 interconnects any number of different computers 102 and 104. A typical combination of resources may include computers 102 or 104 that comprise dedicated or embedded systems, network computers, personal computers, workstations, minicomputers, mainframes, etc.

CyberHub

In the preferred embodiment of the present invention, computer 104 comprises a CyberHub 104, which is a network computing device based on low-cost hardware and Java programming. Generally, the hardware of the CyberHub 104 includes a microprocessor 106, random access memory 108, one or more network interface cards (NICs) 110 coupling the CyberHub 104 to one or more networks 100 (possibly via an optional multi-port hub 112), one or more (optional) managed devices 114 coupled to the CyberHub 104 via one or more I/O interfaces 116, and one or more (optional) data storage devices 118, although other embodiments may include different components.

CyberHub 104 provides an architecture for extensible and inexpensive network connectivity, and at its most basic implementation, can be thought of as a combination of router and server in a box. CyberHub 104 provides all the necessary functions with a small footprint, and with lightweight components, so that it can perform as an embedded device or thin server. The CyberHub 104 technology can be employed in many different applications, ranging from an “instant office” to embedded network connectivity for managed devices.

One salient feature of the CyberHub 104 is its focus on ease of use and manageability to reduce the hidden costs of the networked enterprise. Other unique features of CyberHub include:

extensibility,

security, and

dynamically configurable services.

System Architecture

As shown in FIG. 1, the system architecture of the CyberHub 104 is multi-layered. At its most basic layer, the microprocessor 106 executes an operating system (OS) 120 and networking software (TCP/IP) 122.

At a second layer, the CyberHub 104 also executes a Java Virtual Machine (JVM) 124 that provides a platform for the execution of application services.

A third layer comprises a software platform known as CyberCore 126. CyberCore 126 provides the components for performing the basic functionality on which the applications services are based. At least some of the CyberCore 126 components include: one or more Services 128 for grouping application-specific functions, one or more Class Loaders 130 for loading the application-specific functions (classes) associated the Services 128, one or more Handlers 132 for processing requests for the Services 128 received from the network 100, a URL Registry 134 for associating different ones of the Handlers 132 with specific ones of the requests received from the network 100, and an Access Control List (ACL) Manager 136 for controlling access to the resources of the CyberHub 104, the CyberCore 126, the networks 100, the managed devices 114, etc. Additional components of the CyberCore 126 may include, inter alia, a minimal HTTP Server 138, a Network Updater 140, etc.

These various elements of the system architecture comprise instructions and/or data which, when read and executed by the CyberHub 104, cause the CyberHub 104 to perform the steps or elements of the present invention. The instructions and/or data are usually embodied in or readable from a computer-readable device, medium, or carrier, e.g., a data storage device or memory device coupled locally to the CyberHub 104 or a data storage device or memory device coupled remotely to the CyberHub 104 via the network 100.

Thus, the present invention may be implemented as a method, apparatus, or article of manufacture using standard programming and/or engineering techniques to produce software, firmware, hardware, or any combination thereof. The term “article of manufacture” (or alternatively, “computer program carrier or product”) as used herein is intended to encompass one or more computer programs accessible from any device, medium, or carrier.

Of course, those skilled in the art will recognize that the exemplary environment illustrated in FIG. 1 is not intended to limit the present invention. For example, a client/server architecture is not required, and the present invention could be completed implemented on a single computer, such as a workstation. Indeed, those skilled in the art will recognize that other alternative hardware environments may be used without departing from the scope of the present invention.

Extensibility

In the preferred embodiment, CyberCore 126 and its components 128-140 are written in the Java programming language, which is based on the object-oriented paradigm. Some of the characteristics of this technology include inheritance and dynamic class loading.

The key concept to the CyberCore 126 architecture is its extensibility. When CyberCore 126 starts, it looks in a “jars” subdirectory for filenames that end with .zip or .jar. CyberCore 126 then creates a Class Loader 130 for each file in that subdirectory, wherein each Class Loader 130 corresponds to a Service 128.

Application-specific functions are grouped as Services 128, wherein the classes and resources for a Service 128 are all packaged together in a single “jar” file. Because everything necessary for the operation of a Service 128 is grouped into one file, adding and removing Services 128 is simply a matter of adding or removing files to the CyberHub 104, which may be performed remotely via the networking environment 100.

CyberCore 126 also looks in the root of the jar file for a name of a handlers file. The handlers file contains a list of Handlers 132 to be instantiated by CyberCore 126 for the Services 128.

When a Handler 132 is instantiated, it registers with the URL Registry 134 maintained by CyberCore 126, wherein the URL Registry 134 comprises a list of URLs that the Handler 132 is interested in processing. If two Handlers 132 compete for the same URL, only the first Handler 132 will be registered in the URL Registry 134.

The Handler 132 also receives other information from CyberCore 126, such as a private directory name that corresponds to its assigned location on the optional data storage device 118 for persistent storage and a reference to the ACL Manager 136 for resolving identities and roles of users making requests via to the CyberHub 126.

CyberCore 126 then starts listening for requests from the network 100 and passes the requests on to the Handler 132 registered to process the request. The Handler 132 then invokes one or more various Services 128 to process the request. Finally, the Handler 132 uses the output of the Services 128 to respond to the request.

Security

Since all the Services 128 running in the CyberCore 126 environment run in the same process, interprocess communication is performed using shared variables and methods. Normally, resources such as files and network services are protected based on the user id associated with the process. In the case of CyberCore 126, even a single thread may be used to access resources on the part of a Service 128. For this reason, CyberCore 126 includes the ACL Manager 136 that restricts access to system resources based on the Service 128 requesting the access.

The ACL Manager 136 is used to check access to system resources before carrying out the requested action. The ACL Manager 136 identifies the class requesting the action and then resolves the Service 128 that corresponds to the class. To resolve the Service 128, the ACL Manager 136 references the Class Loader 130 of the class, wherein the name of the Class Loader 130 is the name of the Service 128. The ACL Manager 136 then checks its Access Control List (ACL) for the resource, to see if the desired operation is permitted.

If an “ACL” file exists in the root of the jar file, it is used by the ACL Manager 136 to determine access to a resource. By default, a Service 128 will only be able to access files in a private directory specific to that Service 128; access to all other resources is denied unless specified in the ACL file.

Many extensions to this basic platform have been and can be developed. This is accomplished by implementing Services 128 to handle specific applications and/or specific managed devices 114.

CyberHub Applications

As noted above, the architecture of the CyberHub 104 provides a generic platform for many different applications. A basic implementation may use CyberHub 104 as a network router and/or a server. At another level, CyberHub 104 may be used to provide programmable control to any electronic or electromechanical managed device 114.

For example, using this technology, the inventors developed a prototype application, known as CyberPop, that manages the operation of a soda vending machine. The use of CyberHub 104 in this application allowed the operation of the soda vending machine to be controlled via the Internet 100. Thus, the stock of the soda vending machine could be tracked remotely, algorithms for dynamic pricing could be downloaded as Services 128 into the CyberCore 126 of the CyberHub 104 managing the soda vending machine, and other functions could easily be implemented by downloading new Services 128.

Many extensions to the basic platform have been developed since that original prototype. More importantly, those skilled in the art will recognize that the present invention has an almost infinite number of commercial and industrial applications. One of these applications is described in more detail below.

CyberMed Application

One application of the CyberHub 104 is known as CyberMed, wherein the managed devices 114 are biomedical devices, thus providing a system that leverages evolving network connectivity and systems management technologies in the health care industry.

Biomedical and information technology play an ever-increasing important role in modern hospitals, and the convergence of these previously independent technologies is creating new opportunities. However, a large fraction of the existing biomedical devices are not inherently capable of being networked and thus require a human operator to take note of the device readings on a regular basis. This time-consuming task is performed in a variety of ways and at different frequencies, giving rise to the chance of mistyping and other human errors. In emergency situations, when the life of a patient might be on the line, these secondary activities are usually interrupted, thus degrading the level of detail available after the fact.

The CyberMed application applies the base technology of CyberHub 104 to real life problems associated with biomedical devices 114, such as data collection, real-time visualization, rule-based event handling, user interfaces, data security and systems management. Further needs such as data archival and recovery, back-end integration, inter-company communications, can also be addressed by CyberHub 104. By delivering this functionality, CyberHub 104 provides significant advantages: hospitals can realize cost savings without the need for replacing existing equipment, physicians can have better access to information on their patients, and the patients themselves will have access to a higher level of care.

CyberMed Description

From a hardware perspective, the CyberHub 104 used in the CyberMed application is usually configured to provide one or more network ports 110 and one or more device ports 116. The device ports 116 are then connected to the biomedical devices 114, most of which are equipped with a data port that uses an RS-232 interface. By collecting data from the biomedical device 114 into the CyberHub 104, and providing ways to access this data over the network 100 using widespread standards, CyberHub 104 effectively extends the capabilities of the devices 114 beyond their original design.

The internal data of the biomedical device 114 is exposed through the use of proprietary protocols, that may even vary among different devices 114 from the same vendor, and thus typically require one or more specific Services 128 that conform to these protocols. The Services 128 are analogous to device drivers for an operating system, only their development is made much simpler by using the extensibility of the CyberHub 104 architecture.

CyberMed Systems Management

The preferred embodiment focuses on network-enabling a single hospital room. However, it is anticipated that there would be tens and even hundreds of CyberHubs 104 in a single hospital, with an even larger number of medical devices 114 connected to them, wherein the CyberHub 104 manages all these devices 114 simultaneously.

The CyberHub 104 itself is, by design, a device that is a very easy to manage. Most Services 128 are self-configuring or require only a very simple initial configuration. Additional Services 128 specific to an application or device 114 can be designed following this philosophy. However, management functions of the CyberHub 104 may be restricted by the limited control functions that most devices 114 expose through their data port.

CyberMed Data Collection

The most critical function of the CyberMed application is to enable access by the CyberHub 104 to data being generated by the biomedical devices 114, especially monitoring devices 114. The paradigm for such data access is subscription to a data stream, which means that a program elsewhere in the network 100 expects to receive a certain data element at a fixed rate, based on pre-established policies or on behalf of a human operator. A data element could be anything from a single variable, such as the pulse rate, to an aggregation of variables, possibly from multiple devices 114.

Different units within a hospital have different needs for information. In the intensive care unit, for example, a single patient may require a large number of devices 114, ranging from basic heart rate monitoring to IV drops and ventilators. In other areas, only some basic biophysical parameters need to be monitored. The frequency of the data may also vary according to the unit or the specific patient needs, from a reading every other hour to almost continuous monitoring and recording. All these needs can be accommodated using the present invention.

In many cases, the data of interest is not provided by the device 114 itself, but can be derived from this raw data. For example, when monitoring vital signs, the maximum and minimum values may be the information that a physician is looking for. Rather than having the user look at a long list of values, a statistics “filter” can be applied at the CyberHub 104. Thus, following the subscription model, a program such as a clinical log can request in a single command to the CyberHub 104 to collect data for, say, the pulse rate every 10 seconds, but to receive only the maximum value for a period of one hour. Other filters can provide additional functionality.

CyberMed User Interface and Data Visualization

Once the data has been captured, and in order to be used effectively, it needs to be displayed in a meaningful way. Another goal of CyberHub 104 is to use Internet 100 technology to generate data visualization displays including real-time and statistical information. Generally, developers must work closely with end users to identify what data is needed in each situation and the most effective way to represent this data.

In the preferred embodiment, CyberHub 104 executes a Service 128 that provides a graphical representation of the front panel of the managed device 114. This graphical representation is transmitted to another computer 102 connected to the CyberHub 104 via the network 100 for display. Further, the graphical representation may be updated with data collected by the CyberHub 104 from the managed device 114, thus simulating in real-time (with a minimum delay) what would be seen if the user were looking directly at the device 114 itself. The advantage of this approach is that it provides the least abstract representation of the data, and gives the user who is familiar with these devices 114 an immediate and straightforward view of the situation.

However, this may not be the most effective use of such data. One problem is that it is very tightly coupled with the data source itself (i.e., a specific device 114 model), when the real value may reside in the information being conveyed. For example, a physician may be interested in the oxygen saturation level, without being concerned about whether it was one brand of device 114 or another that obtained this data. CyberHub 104 provides the flexibility through downloadable and customizable Services 128 to display simultaneously data from multiple devices 114, and at the same time track, when necessary such as for liability reasons, the specific data source that generated each piece of information.

CyberMed Data Logging

Some, and perhaps most, of the data being collected will be consumed for real-time display or event handling and is thus transient. However, there is also a need for persistent storage, such as a log. This may be implemented using the Java DataBase Connection (JDBC) API to databases. The data store itself can reside in the memory 108 or data storage device 118 of the CyberHub 104 for very basic logging.

Collected data may also be stored on an external relational database management system (RDBMS). The need for this is obvious: huge amounts of data could be generated, which CyberHub 104, in the proposed configuration, would not be able to store locally, and this data may need to be aggregated across different rooms and/or hospital units.

CyberMed Rules-Based Event Handling

Services 128 executed by CyberHub 104 could also be used to perform rules-based event handling. Specifically, CyberHub 104 can be programmed to take certain actions when certain conditions are met, as determined from data collected from the managed device 114. For example, an obstetrician may need to be notified when the fetal heart rate of one a patient exceeds a certain value; a surgeon may need to monitor blood pressure over time for a patient that has undergone a heart bypass; etc.

Additionally, more complex data transformations may be explored. For example, by correlating data generated by several devices 114, the Services 128 executed by the CyberHub 104 may identify a specific clinical condition and which could then be handled by a Service 128 or another computer 102.

Logic of the CyberHub

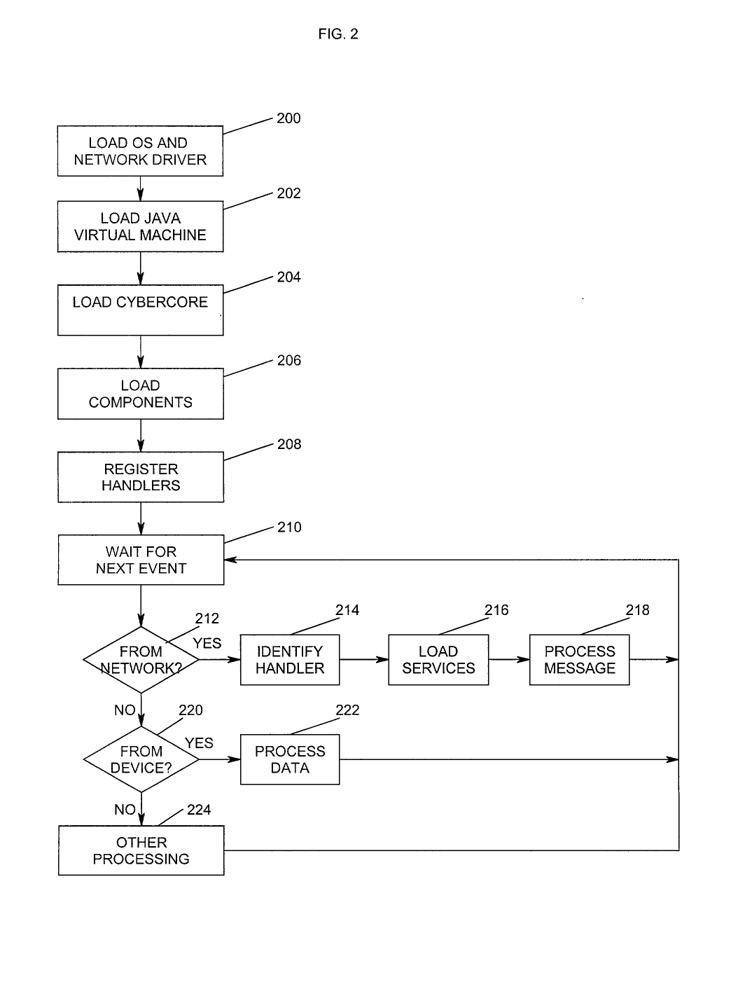

A flowchart that illustrates the logic of the CyberHub 104 of the present invention is shown in FIG. 2. Those skilled in the art will recognize that this logic is provided for illustrative purposes only and that different logic may be used to accomplish the same results.

Block 200 represents the CyberHub 104 loading the operating system (OS) 120 and networking software (TCP/IP) 122 in the microprocessor 106 for execution.

Block 202 represents the CyberHub 104 loading the Java Virtual Machine (JVM) 124 in the microprocessor 106 for execution.

Block 204 represents the CyberHub 104 loading the CyberCore 126 in the microprocessor 106 for execution.

Block 206 represents the CyberHub 104 loading the components of the CyberCore 126 in the microprocessor 106 for execution. These components include the application Services 128, the Class Loaders 130, the Handlers 132, the Registry 134, and the ACL Manager 136. These components may also include the minimal HTTP Server 138 and the Network Updater 140.

Block 208 represents the Handlers 132, after they are instantiated, registering with the Registry 134.

Blocks 210-224 together comprise a loop for processing requests received from the network 100, data collected from the managed device 114, etc.

Block 210 represents the CyberCore 126 waiting for the next event to occur, i.e., waiting for the next input from the network 100 and/or the managed device 114.

Block 212 is a decision block that represents the CyberCore 126 determining whether the event comprises the receipt of a message from the network 100, i.e., from another computer 102. If so, control transfers to block 214; otherwise, control transfers to block 220.

Block 214 represents the CyberCore 126 identifying the Handler 132 to handle the message based on the information stored by the Registry 134.

Block 216 represents the Handler 132 loading the Services 128 (if necessary) to process the message received from the network 100.

Block 218 represents the Services 128 processing the message received from the network 100. Thereafter, control transfers to Block 210.

Block 220 is a decision block that represents the CyberCore 126 determining whether the event comprises the receipt of data from the managed device 114. If so, control transfers to block 222; otherwise, control transfers to block 224.

Block 222 represents the Services 128 processing the data received from the managed device 114. Thereafter, control transfers to Block 210.

Block 224 represents the CyberCore 126 performing other processing. Thereafter, control transfers to Block 210.

Conclusion

This concludes the description of the preferred embodiment of the invention. The following describes some alternative embodiments for accomplishing the present invention.

For example, any type of managed device could be used with the present invention. In addition, any type of computer configuration and/or network configuration could benefit from the present invention.

In summary, the present invention discloses a network computing device based on low-cost hardware that provides an architecture for extensible and inexpensive network connectivity. The system architecture is multi-layered: (1) at a first layer, the system executes an operating system and networking software; (2) at a second layer, the system executes a Java Virtual Machine (JVM) that provides for the execution of application services related to the managed device 114; and (3) at a third layer, the system executes a software platform that provides components for performing the basic functionality on which the application services are based. At least some of the components of the software platform include: one or more of the Services for grouping application-specific functions related to the managed device, one or more Class Loaders for loading the application-specific functions associated the Services, one or more Handlers for processing requests for the Services received from the network, a Registry for associating different ones of the Handlers with specific ones of the requests received from the network, and an Access Control List (ACL) Manager for controlling access to the resources of the computing device.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. An extensible thin server for computer networks, comprising:
(a) a computing device coupled both to a network; and
(b) a software platform, executed by the computing device, the software platform being comprised of a plurality of components for providing basic functionality on which one or more applications are based, wherein the components are selected from a group comprising: one or more Services for grouping application-specific functions, one or more Class Loaders for loading the application-specific functions associated with the Services, one or more Handlers for processing requests for the Services received from the network, a Registry for associating different ones of the Handlers with specific ones of the requests received from the network, and an Access Control List (ACL) Manager for controlling access to the resources of the computing device and the software platform.

2. The extensible thin server of claim 1 above, further comprising means for packaging a Service in a single file.

3. The extensible thin server of claim 1 above, further comprising means for adding Services by adding files to the extensible thin server.

4. The extensible thin server of claim 3 above, wherein the means for adding further comprising means for adding Services by downloading the files to the extensible thin server.

5. The extensible thin server of claim 1 above, further comprising means for deleting Services by deleting files from the extensible thin server.

6. The extensible thin server of claim 1 above, wherein the Registry comprises a list of Uniform Resource Locators (URLs) that the Handler processes.

7. The extensible thin server of claim 1 above, further comprising a managed device coupled to the computing device.

8. The extensible thin server of claim 7 above, wherein one or more of the Services provides programmable control for the managed device.

9. The extensible thin server of claim 7 above, wherein one or more of the Services process data collected from the managed device.

10. The extensible thin server of claim 9 above, wherein one or more of the Services formats the collected data for display.

11. The extensible thin server of claim 9 above, wherein one or more of the Services transfers the collected data to a remote device via the network.

12. The extensible thin server of claim 9 above, wherein one or more of the Services logs the collected data to a storage device.

13. The extensible thin server of claim 12 above, wherein the storage device is local to the computing device.

14. The extensible thin server of claim 12 above, wherein the storage device is remote from the computing device.

15. The extensible thin server of claim 1 above, wherein one or more of the Services provides rule-based event handling.

16. The extensible thin server of claim 7 above, wherein the managed device is a biomedical device.

17. The system of claim 16 above, wherein one or more of the Services collect data from the biomedical device.

18. The system of claim 17 above, wherein one or more of the Services applies a filter to the collected data from the biomedical device.

19. The system of claim 17 above, wherein the data is collected in response to received commands.

20. The system of claim 17 above, wherein one or more of the Services creates data visualization displays for the collected data.

21. The system of claim 17 above, wherein the data visualization displays resemble a control panel of the biomedical device.

22. The system of claim 17 above, wherein one or more of the Services displays data from a plurality of the biomedical devices substantially simultaneously.

23. The system of claim 17 above, wherein one or more of the Services logs the data collected from the biomedical device.

24. The system of claim 17 above, wherein one or more of the Services perform rules-based event handling.

25. A method for operating an extensible thin server in a computer network, comprising the steps of:
(a) loading a software platform on a computing device coupled to a network, the software platform being comprised of a plurality of components for providing basic functionality on which one or more applications are based, wherein the components are selected from a group comprising: one or more Services for grouping application-specific functions, one or more Class Loaders for loading the application-specific functions associated with the Services, one or more Handlers for processing requests for the Services received from the network, a Registry for associating different ones of the Handlers with specific ones of the requests received from the network, and an Access Control List (ACL) Manager for controlling access to the resources of the computing device and the software platform; and
(b) executing the software platform on the computing device, including selectively executing the application Services, the Class Loaders, the Handlers, the Registry, and the ACL Manager.

26. An article of manufacture comprising a computing device coupled to a network and embodying logic executable by the computing device to perform method steps for operating as an extensible thin server in a computer network, the method comprising the steps of:
(a) loading a software platform on computing device, the software platform being comprised of a plurality of components for providing basic functionality on which one or more applications are based, wherein the components are selected from a group comprising: one or more Services for grouping application-specific functions, one or more Class Loaders for loading the application-specific functions associated the Services, one or more Handlers for processing requests for the Services received from the network, a Registry for associating different ones of the Handlers with specific ones of the requests received from the network, and an Access Control List (ACL) Manager for controlling access to the resources of the computing device and the software platform; and
(b) executing the software platform on the computing device, including selectively executing the application Services, the Class Loaders, the Handlers, the Registry, and the ACL Manager.
